(19) United States
(12) Patent Application Publication
(10) Pub. No.: US 2013/0288343 A1
(43) Pub. Date: Oct. 31, 2013

(54) BIOLOGICAL SAMPLE HOLDER AND METHOD OF ASSEMBLING A STORAGE DEVICE

(71) Applicants: Andrew Francis Page, Wilmington, DE (US); Breck Olland Parker, Saco, ME (US); Stevan Paul Tortorella, Wells, ME (US)

(72) Inventors: Andrew Francis Page, Wilmington, DE (US); Breck Olland Parker, Saco, ME (US); Stevan Paul Tortorella, Wells, ME (US)

(73) Assignee: GE HEALTHCARE UK LIMITED, LITTLE CHALFONT (GB)

(21) Appl. No.: 13/978,998

(22) PCT Filed: Jan. 16, 2012
(86) PCT No.: PCT/EP12/50582

§ 371 Date: Jul. 10, 2013

Related U.S. Application Data
(60) Provisional application No. 61/433,298, filed on Jan. 17, 2011.

(30) Foreign Application Priority Data
Feb. 7, 2011 (GB) 1102009.6

(51) Int. Cl. B01L 3/00

(52) U.S. Cl. CPC B01L 3/5085
USPC 435/283.1; 29/428

(57) ABSTRACT

Embodiments of the present invention, disclose a biological sample holder comprising a stake of biologically inert material, and a biological sample storage medium fixed to or retained on the stake by a retaining portion. This provides a means of holding a biological sample which is easy to handle and suitable for automation, for example in an array of such holders, allowing processing of multiple biological samples in parallel.

### FIELD OF THE INVENTION

The present invention relates to a biological sample holder and to a method of assembling a storage device.

### BACKGROUND OF THE INVENTION

Biological samples, such as blood samples taken for drug discovery and saliva taken for DNA profiling in criminal investigations, are typically held in an absorbent storage medium, which may comprise a membrane impregnated with chemicals for stabilising the sample. The samples are allowed to dry and, once dry, the biological storage medium can be transported to a testing facility for analysis.

Typically, when the sample is to be tested, small pieces of the sample holding membrane are punched out. These pieces are small enough to minimise wasteful consumption of the sample but large enough to be handled and also to contain enough biological material for the test to be carried out successfully.

Conventionally, this processing is done manually and samples are tested individually. However, greater demand for storage and extraction of genetic material has led to a requirement for greater throughput; the standard is now hundreds or thousands of extractions per day. Currently, matrix-based solutions for nucleic acid storage and extraction are limited in this respect because automated or multiple-sample processing of the samples is not compatible with the storage medium.

It is an object of the present invention to mitigate the limitations associated with storing nucleic acid samples in matrices and provide a way to increase the speed and efficiency of sample processing.

### SUMMARY OF THE INVENTION

In accordance with a first aspect of the present invention, there is provided a biological sample holder comprising a stake of biologically inert material, and a biological sample storage medium fixed to or retained on the stake by a retaining portion of the stake, wherein, said medium includes a front surface and opposing rear surface, and wherein said retaining portion extends through the medium and beyond said front and rear surfaces.

The retaining portion may comprise a recess in the stake, into which an edge of biological sample storage medium protrudes. This prevents excessive movement of the biological sample storage medium.

The biological sample storage medium may comprise a membrane for absorbing liquid biological samples, which comprises a matrix disc.

The biological sample storage medium may be made of a paper material.

The stake may be tapered, optionally narrowing toward a distal end.

The stake may be of plastics material.

In accordance with a second aspect of the present invention, an array of biological sample holding devices supported on a base plate is provided. These stakes may each comprise biologically inert material, and may retain a biological sample storage medium thereon by means of a retaining portion of the stake, This provides the ability to process multiple biological samples in parallel.

The base plate may comprise at least one asymmetric feature located on an outside edge.

The base plate and the stake of the biological sample storage holder may be of a plastics material.

The base plate may comprise a grid-coordinate system to identify each of the stakes.

A gasket or seal may be provided on the base plate around each of the stakes that reduces or prevents evaporation and/or spillage losses during processing of the biological sample.

The base plate may comprise a computer readable tag to provide reliable identification of the samples.

In accordance with a third aspect of the present invention, there is provided an apparatus for storing and processing in parallel plural biological samples, the apparatus comprising:

an array of biological sample holders; and

a tray comprising an array of wells;

wherein the position of the wells corresponds to the position of the devices in said array, and the depth and diameter of the wells exceeds the length and diameter of the stakes in said array.

The tray may be a polymerase chain reaction (PCR) tray.

In accordance with a fourth aspect of the present invention, there is provided a method of assembling a device for storing and processing at least one biological sample, the method comprising:

providing one or more stakes; and

fixing or retaining one or more biological sample storage medium/media onto the stake(s) such that the or each stake at least partly penetrates a first surface of its associated biological sample storage medium and emerges from an opposing side of said associated medium.

The method may comprise providing a plurality of stakes arranged in a two dimensional array on a base plate.

The base plate and stakes may be made of a plastics material and may be injection moulded as a single component. This has the advantage that the component may be fabricated in a simple single step. Alternatively, the base plate and the or each stake may be manufactured as discrete parts that are fixed together. This has the advantage that the design of the array is flexible. A gasket or seal may be provided around the or each stake.

The biological sample storage medium may be fixed to or retained on said stake by a heat staking process if the stake is of plastics, or retained on the stake by an interference fit.

The method may also comprise, in any suitable order, forming a biological sample storage medium from a matrix; fixing it to, or retaining it on a stake; and applying a biological sample to the biological sample storage medium.

A further aspect of the invention provides the use of the holder of the first aspect, the array of the second aspect or the apparatus of the third aspect for storing and/or processing a biological sample.

Further features and advantages of the invention will become apparent from the following description of illustrative embodiments of the invention, given by way of example only, which is made with reference to the accompanying drawings.

### BRIEF DESCRIPTION OF THE DRAWINGS

FIG. 1a shows a perspective exploded view of a device for holding a disc of biological sample holding membrane according to a first embodiment of the present invention;

FIG. 1b shows a perspective view of a device for holding a disc of biological sample holding membrane according to the first embodiment of the present invention;

FIG. 2a shows a longitudinal cross-section view of a biological sample holder according to a second embodiment of the present invention;

FIG. 2b shows longitudinal cross-section views of a biological sample holder with a retainer formed by a heat-staking process according to a third embodiment of the present invention;

FIG. 3a shows a perspective view of an array of biological sample holders according to a fourth embodiment of the present invention;

FIG. 3b shows an exploded perspective view of an array of biological sample holders according to a fifth embodiment of the present invention;

FIG. 3c shows an exploded perspective view of a PCR tray corresponding with an array of biological sample holders according to a sixth embodiment of the present invention;

FIG. 3d shows a cross-section view of a PCR well according to the sixth embodiment of the present invention;

FIG. 4 shows a cross-section view of the edge of the base plate of an array of devices for holding discs of biological sample holding membrane according to the seventh embodiment of the present invention;

FIG. 5 shows a perspective view of an array of devices for holding discs of biological sample holding membrane comprising a gasket according to an eighth embodiment of the present invention;

FIG. 6 shows a plan view of the base plate of an array of devices for holding discs of biological sample holding membrane comprising a grid-coordinate reference system according to a ninth embodiment of the present invention;

FIG. 7 shows a side aspect of an array of devices for holding discs of biological sample holding membrane comprising a computer readable tag coded with identification data according to a tenth embodiment of the present invention;

FIG. 8 shows a plan view of an array of devices for holding discs of biological sample holding membrane, wherein the base plate of the array comprises an asymmetric external geometry according to an eleventh embodiment of the present invention.

### DETAILED DESCRIPTION OF THE INVENTION

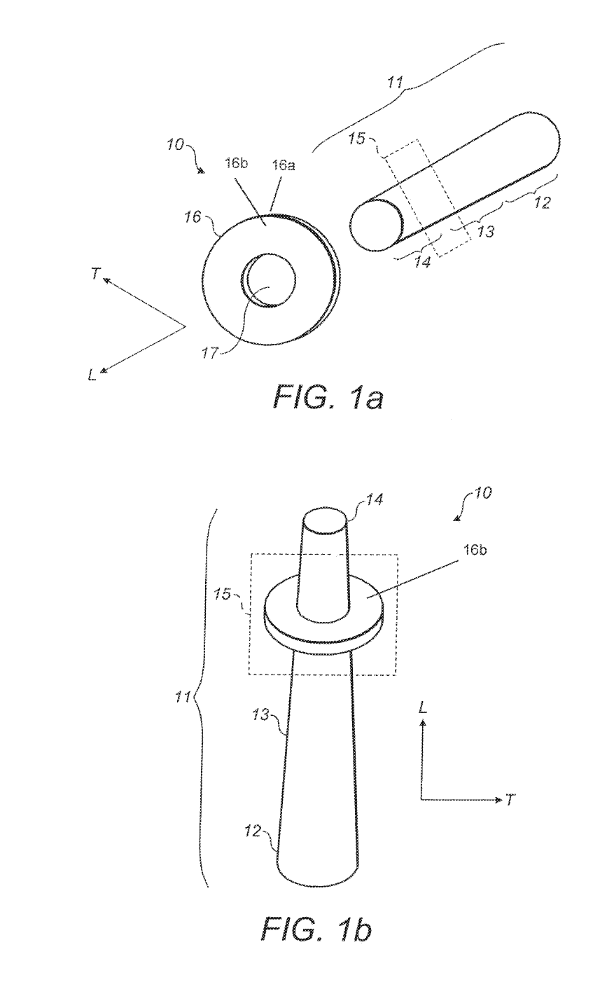

FIG. 1a shows an exploded perspective view of a biological sample holder 10 according to an embodiment of the present invention. FIG. 1b shows a perspective view of a biological sample holder 10 in assembled form according to the embodiment. Longitudinal and transverse axes are defined by the arrows in FIGS. 1a and 1b and labelled L and T respectively. The biological sample holder 10 comprises a stake 11 having a base portion 12, a shaft portion 13, a tip portion 14 and a retainer or retaining portion 15 which fixes or retains, on the stake 11, a piece of a biological sample holding medium. Typically, the stake 11 is 20 mm long and 2 mm in diameter at its base portion 12. The stake 11 may be solid or hollow. In this example, the medium is a membrane (referred to hereinafter as a matrix disc 16). The matrix disc 16 comprises a substantially flat, circular disc of matrix material having a opposing front 16a and rear 16b surfaces, suitable for holding wet or dried biological material, with a hole 17 substantially in the centre of the matrix disc 16. The stake 11 extends through the matrix disc 16 beyond the front and rear surfaces 16a and 16b. The matrix disc 16 may be made of a paper material, such as FTA® elute paper. Typically, the matrix disc 16 and hole 17 are formed by punching the matrix disc 16 from a larger sheet of membrane. The matrix disc 16 is typically 3 mm in diameter and 1 mm thick. The hole 17 is typically 1 mm in diameter and may be designed such that it provides an interference fit with the tip portion 14. The hole 17 may be cut by the tip portion 14 of the stake 11.

In an embodiment, the biological sample holder 10 is substantially circular in transverse cross-section, though it will be apparent to one skilled in the art that embodiments with other cross-sectional profiles are also possible.

The tip portion 14 of the biological sample holder 10 is inserted into the hole 17 in the centre of the matrix disc 16. In an embodiment, the stake is tapered such that the base portion 12 has a larger diameter than the tip portion 14 in order to prevent excessive movement of the matrix disc 16 along the shaft portion 13 toward the base portion 12 during assembly. The additional diameter of the base portion 12 also provides an increase in overall structural strength, to minimise the chance of damage to the shaft, while the diameter of the tip portion 14 is still small enough to be accommodated by the hole 17 in the matrix disc 16. The biological sample holder 10 may have any suitable longitudinal cross sectional shape. It may be cylindrical, tapered, or stepped from the base portion 12 to the tip portion 14.

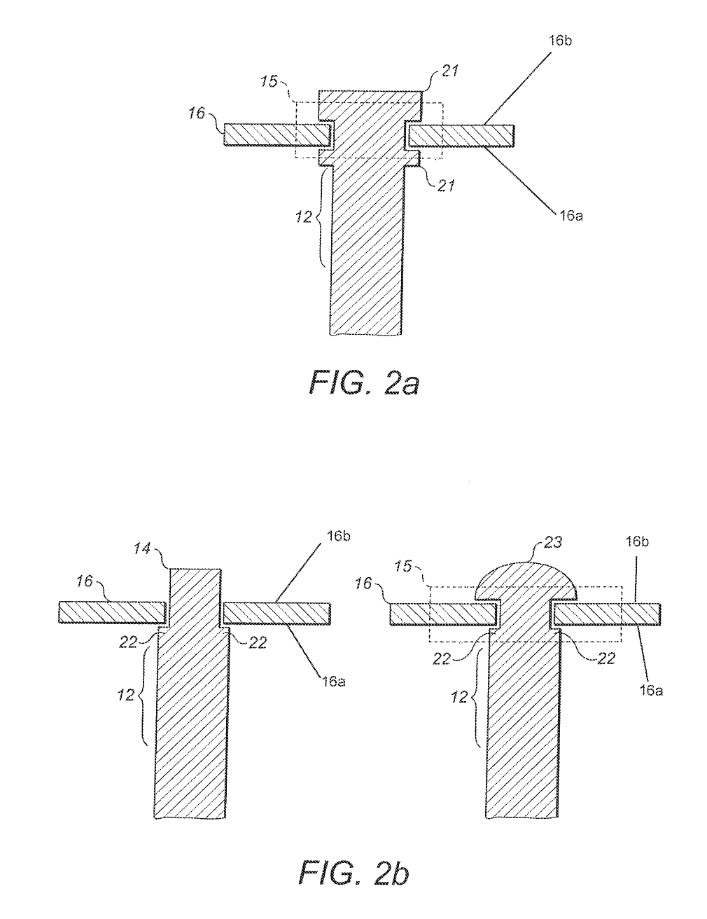

FIG. 2a shows an embodiment of the present invention wherein the retainer 15 of the biological sample holder 10 comprises features to prevent excessive movement of the matrix disc 16 along the longitudinal axis of the shaft portion 12 such as to prevent the matrix disc 16 from moving toward the base portion 12 or from being completely removed from the biological sample holder 10. The longitudinal cross-sectional profile of the shaft may comprise one or more protrusions 21 designed to prevent movement of the matrix disc 16.

The protrusions 21 may be formed around part of, or the entire circumference of the stake 11. In order for the matrix disc 16 to be fitted to the stake 11, the matrix material from which the matrix disc 16 is made may be flexible such that the hole 17 can expand to pass the outermost protrusion 21 and, once past the outermost protrusion 21, contract to lie within the recess formed between the outermost and innermost protrusions 21. In another embodiment according to the present invention, as shown in FIG. 2b, the retainer 15 comprises a tip portion 14 which has a smaller diameter than the shaft portion 12 such that a shoulder 22 is formed at the interface between the shaft portion 12 and the tip portion 14. The tip portion 14 is deformed, e.g. by the application of heat and pressure to a stake 11 of plastics material, in a heat staking process to trap the matrix disc 16 between the shoulder 22 and the deformed tip portion 23 and thus prevent movement along the longitudinal axis of the biological sample holder 10.

The biological sample holder 10 may be made from any chemically and biologically inert material that can withstand a temperature of a PCR reaction-currently around 95° C., although higher or lower temperatures could be employed. Suitable materials include polycarbonate, polystyrene, or polypropylene. The biological sample holder 10 must be rigid and strong enough to withstand the forces applied to it when mounting the matrix disc 16 on to the tip portion 14.

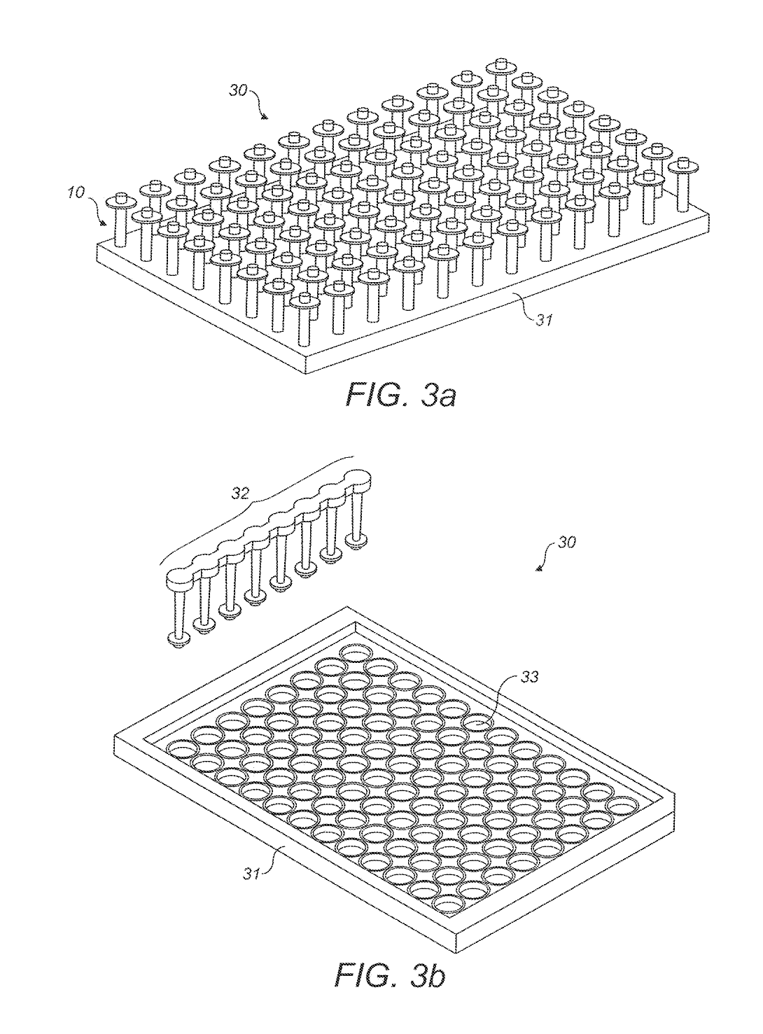

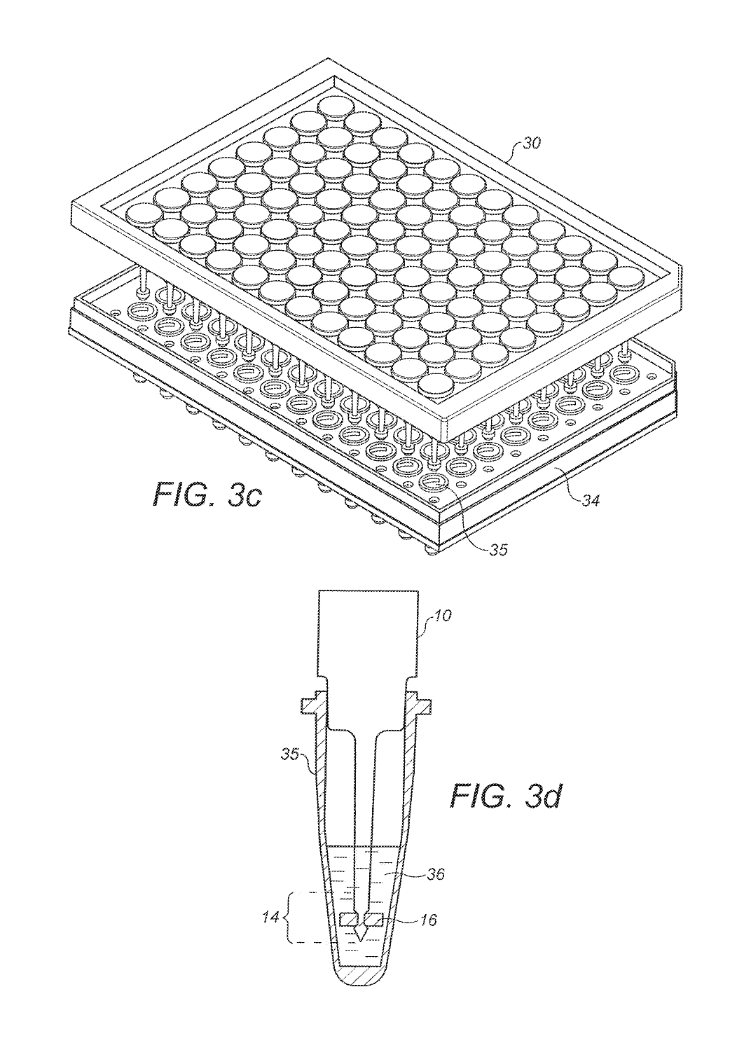

In a further embodiment according to the present invention, depicted in FIG. 3a, a plurality of biological sample holders 10 are arranged to form an array 30 such that multiple samples may be processed in a single step. The holders may be as shown and described with reference to FIG. 1, 2a or 2b.

Each of the biological sample holders 10 are physically connected at the base portion 12 to a base plate 31.

In a preferred embodiment the array 30 of biological sample holders 10 and the base plate 31 are manufactured by injection moulding as a single component. In this embodiment, it may be particularly advantageous to form the stakes 11 without the protrusions 21, since it is difficult to form a two-dimensional array of stakes 11 having these protrusions as part of a single injection mould. Accordingly, in this embodiment, it may be advantageous to form stakes 11 having a reduced tip diameter, and use the heat-staking method to form the retainer 15, as described above in relation to FIG. 2b.

Other methods of manufacture are envisaged; for example, the biological sample holders 10 and the base plate 31 may be manufactured as separate parts as shown in FIG. 3b. This allows greater flexibility in the design of the array 30 and, in particular, in the number of biological samples holders 10 that form the array 30. The biological sample holders 10 may be moulded individually or in rows 32, for example, and the base plate may simply be formed with an array of holes 33 into which the base portions 11 of the biological sample holders 10 sit. The biological sample holders 10 may be fixed to the base plate 31 by an ultrasonic weld or any other suitable method.

The dimensions of the base plate 31 and the positions of the biological sample holders 10 on the base plate 31 are chosen to correspond with the dimensions and positions of wells in a tray of wells. In this example the tray is a polymerase chain reaction (PCR) type tray 34 and the positions of wells 35 within the PCR tray 34 may be as shown in FIG. 3c. Typically, the wells 35 in the PCR tray 34 will be at least partially filled with an elution liquid 36 designed to elute the nucleic acid. In the arrangement shown in FIGS. 3a, 3b and 3c, the biological sample holders 10 form an 8×12 rectangular array, however, it will be appreciated that any other one- or two-dimensional arrangement corresponding to an equivalent arrangement of wells 35 in a PCR tray 34 is possible. In a preferred embodiment according to the present invention, the external dimensions of the base plate 31 correspond to the SBS standard laboratory footprint such that the array 30 may be handled by standard laboratory material handling equipment. Typically, the base plate is 127.76 mm long and 85.48 mm wide. The height of the biological sample holder 10 is designed such that when the base plate 31 of the array 30 is attached to the PCR tray 34, the tip portion 14 of the biological sample holders 10 reaches far enough into to the well 35 that the matrix disc 16 may be immersed in elution liquid 36 without the tip portion 14 or the matrix disc 16 coming into physical contact with the internal walls of the PCR well 35. This is illustrated in FIG. 3d. There is also a design restriction on the diameter of the matrix disc 16 to be smaller than the diameter of the PCR well 35, and for the central longitudinal axis of the biological sample holder 10 to be substantially parallel to the central longitudinal axis of the PCR well 35.

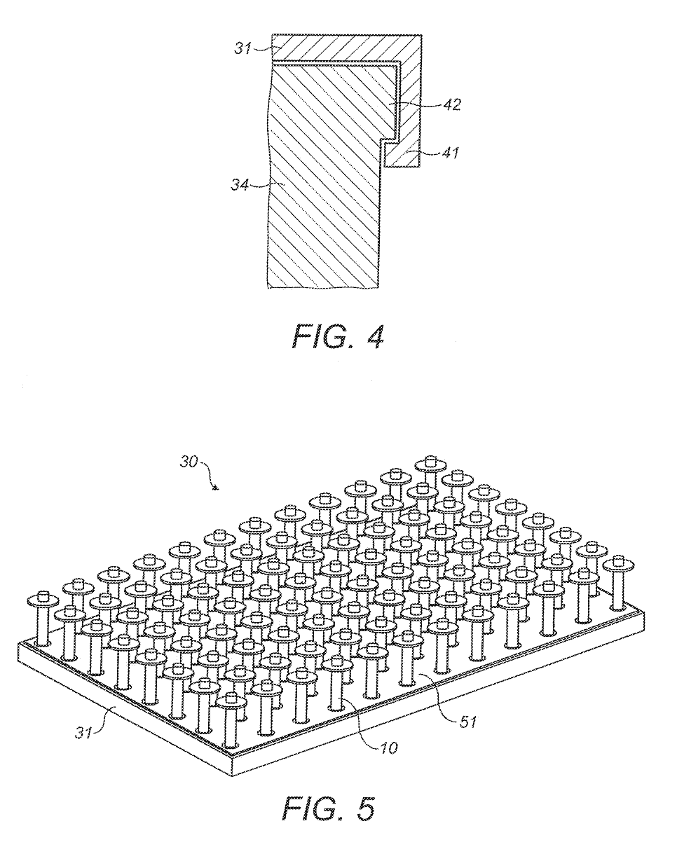

FIG. 4 shows, in cross-section, a further embodiment of the present invention in which the external edges of the base plate 31 of the array 30 form a mechanical clip 41 to hold the array 30 in place on the PCR tray 34. The edge of the PCR tray 34 is shown in contact with the base plate 31 of the array 30.

The PCR tray 34 has a corresponding protrusion 42 at its edge, which binds with the clip 41. The dimensions of the clip 41 are such that it is flexible enough that the base plate 31 may be attached to and removed from the PCR tray 34 by application of appropriately directed forces, but stiff enough that there is negligible movement of the base plate 31 relative to the PCR tray 34 when the two components are connected and such that the base plate 31 cannot detach from the PCR tray 34 inadvertently when the combined components are gripped solely by the edges of the base plate 31, either by a human operator or a mechanical handling system.

In a further embodiment according to the present invention, as shown in FIG. 5, the array 30 comprises a gasket 51 fixed to the base plate 31 and surrounding each of the biological sample holders 10. The gasket 51 is manufactured from an impermeable material and is of sufficient thickness and flexibility to form a suitable seal between the base plate 31 of the array 30 and the PCR tray 34 to minimise loss of the elution liquid 36 by evaporation or spillage. Rather than the continuous gasket 51, individual seals may be employed for each stake, for example ‘O’ ring seals (not shown).

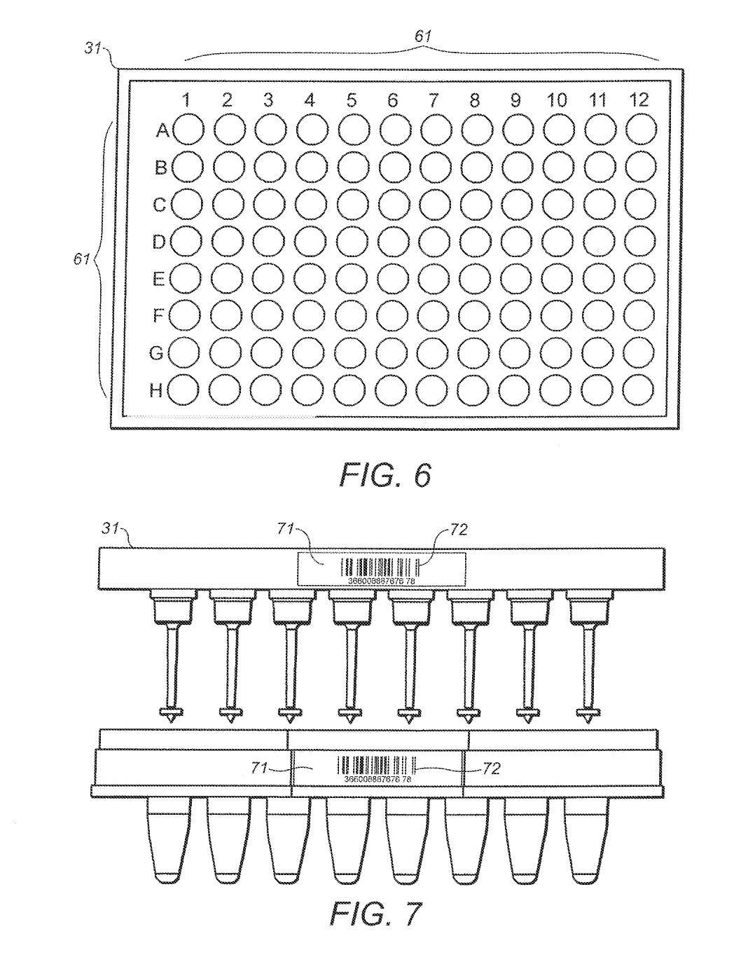

FIG. 6 shows an embodiment according to the present invention wherein the base plate 31 comprises identifying grid-coordinates 61 correlating with the positions of each of the biological sample holders 10, to enable identification and addressing of individual samples.

FIG. 7 shows a further embodiment according to the present invention wherein the base plate 31 comprises a identification tag 71 comprising coded computer readable identification information. In an embodiment, the tag 71 comprises a barcode 72 that can be scanned and compared with a database of sample identification codes; other types of tag may be used, for example an RFID tag.

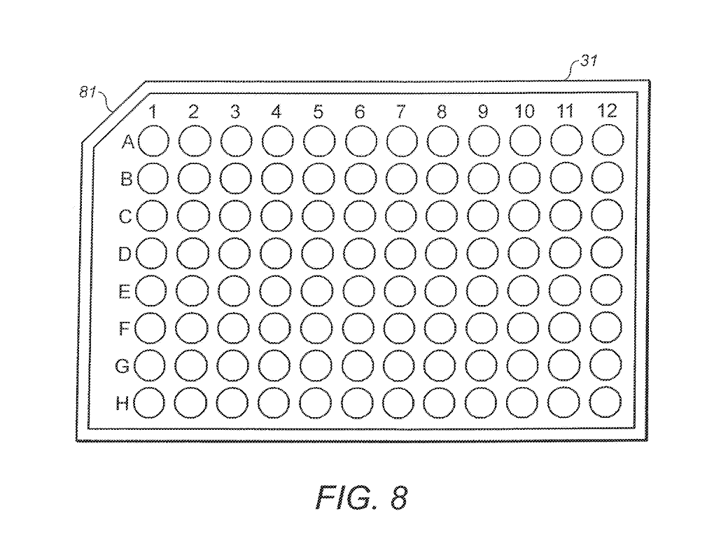

In a further embodiment according to the present invention, as shown in FIG. 8, the base plate 31 comprises an asymmetric geometry such that the array 30 can only couple with the PCR tray 34 in a single orientation. In the embodiment shown, this is achieved by incorporating a bevel 81 in one of the four corners of the base plate 31 and corresponding PCR tray 34. However, it will be apparent that other geometries will also achieve the same result.

The biological sample holders 10 and the array 30 described by the above embodiments may be used in any process whereby a liquid sample is stored in dried form within a matrix material and then subsequently removed from the matrix material by elution. A typical process compatible with DNA amplification techniques may involve the following steps: inserting the one or more biological sample holders 10 in the wells of a tray with each well having a volume of at least 800 μL so that each matrix is immersed in 500 μL of water. Transferring the one or more biological sample holders 10 to a PCR tray 34 that contains 30 μL of water in each well 35; transferring the array 30 and PCR tray 34, together, to a thermal cycler and heating to 95° C. for thirty minutes; pulse vortexing the array 30 and PCR tray 34, together, sixty times; spinning the array 30 and PCR tray 34, together, in a centrifuge for thirty seconds at 1000×g; removing the array 30 from the PCR tray 34; and passing the PCR tray 34 on to be analysed.

The above embodiments are to be understood as illustrative examples of the invention. Further embodiments of the invention are envisaged. For example, in some embodiments the shoulder portion 22 of FIG. 2b is omitted and the shaft portion 13 tapered, in which case the retainer 15 holding the matrix disc 16 comprises the taper of the stake 11 and the deformed tip portion 23. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A biological sample holder comprising a stake of biologically inert material, and a biological sample storage medium fixed to or retained on the stake by a retaining portion of the stake, wherein, said medium includes a front surface and opposing rear surface, and wherein said retaining portion extends through the medium and beyond said front and rear surfaces.

2. The holder of claim 1, wherein the retaining portion comprises a recess in the stake and into which an edge of biological sample storage medium protrudes.

3. The holder of claim 1, wherein the biological sample storage medium comprises a membrane for absorbing liquid biological samples.

4. The holder of claim 1, wherein the biological sample storage medium comprises a matrix disc.

5. The holder of claim 1, wherein the biological sample storage medium is of a paper material.

6. The holder of claim 1, wherein the stake is tapered.

7. The holder of claim 1, wherein the stake is of a plastics material.

8. An array of biological sample holders, each of the holders comprising a stake of biologically inert material, each stake including a retaining portion suitable for retaining a biological sample storage medium thereon, the array being supported on a base plate.

9. The array of claim 8, in which the base plate comprises at least one asymmetric feature located on an outside edge of the base plate.

10. The array of claim 8, wherein the base plate and/or the stake is of a plastics material.

11. The array of claim 8, comprising a grid-coordinate system to identify each of the stakes.

12. The array of claim 8, comprising a gasket or seal on the base plate around each of the stakes.

13. The array of claim 8, comprising a computer readable tag.

14. An apparatus for storing and processing in parallel plural biological samples, the apparatus comprising:
the array of claim 8; and
a tray comprising an array of wells;
wherein the position of the wells corresponds to the position of the biological sample holders in said array, and the depth and diameter of the wells exceeds the length and diameter of the biological sample holders in said array.

15. The apparatus of claim 14, wherein the tray is suitable for a polymerase chain reaction (PCR).

16. A method of assembling a biological sample holder for storing and processing at least one biological sample, the method comprising:
providing one or more stakes; and
fixing or retaining one or more biological sample storage medium/media onto or on the or each stake such that the or each stake penetrates a front surface of its associated biological sample storage medium and emerges from an opposing second surface of said associated medium.

17. The method of claim 16, comprising providing a plurality of stakes arranged in a two dimensional array on a base plate.

18. The method of claim 17, wherein the base plate and stake is of plastics, and the method comprises injection moulding the base plate and the stakes as a single component.

19. The method of claim 17, comprising manufacturing the base plate and the or each stake as discrete parts and fixing said discrete parts together.

20. The method of claim 17, wherein a gasket or seal is provided on the base plate around the or each stake.

21. The method of claim 16, wherein the or each stake is of plastics and a said biological sample storage medium is fixed to a said stake by a heat staking process.

22. The method of claim 16, wherein the biological sample storage medium is retained on the stake by an interference fit.

23. The method of claim 16, comprising, in any suitable order: forming a biological sample storage medium from a matrix; fixing said biological sample storage medium to a stake; and applying a biological sample to said biological sample storage medium.

24. The method of claim 23, further comprising the step of producing a hole in the medium using a tip of the stake.

25. (canceled)
